(19) United States
(12) Patent Application Publication
(10) Pub. No.: US 2011/0119193 A1
(43) Pub. Date: May 19, 2011

(54) TECHNICAL PROJECT MANAGEMENT SYSTEM

(75) Inventors: James Kevin McLees, Richmond, VA (US); Kellie Michele Smirnoff, Jacksonville, FL (US); Shantel LaTrece Stills, Jacksonville, FL (US); Peter Babb, Charlotte, NC (US); Thomas Holleman, Highland Park, IL (US); Matthew W. Moyer, North Riverside, IL (US)

(73) Assignee: BANK OF AMERICA CORPORATION, Charlotte, NC (US)

(21) Appl. No.: 12/618,238

(22) Filed: Nov. 13, 2009

(51) Int. Cl. G06Q 10/00

(52) U.S. Cl. 705/301; 705/348

(57) ABSTRACT

Systems, methods, and computer program products are defined that provide for managing a technical project. In particular, embodiments provide for an end-to-end project delivery tool that includes planning, defining the requirements, designing, building, approving and providing communication/reporting of the technical project. The technical project management delivery tool herein described automates the capture of data and other functionality, such as identification of technical requirements, design infrastructure, build workflows and the like, to add increased efficiency as it relates to the design and build phases of a technical project.

### FIELD

In general, embodiments herein disclosed relate to systems, methods, and computer program products for technical project management and, more specifically, a comprehensive system for managing the delivery of a technical project.

### BACKGROUND

Many projects undertaken by large corporations, such as computer network infrastructure design projects and the like, involve a myriad of tasks that need to be completed in order to see the project through from the planning stage to the build/implementation phase and subsequent approval and reporting. Many of these tasks are manual and otherwise time-consuming. These various tasks include, but are not limited to, drafting and cataloging technical requirements; validation of business requirements and translation of business requirements into technical requirements; collaboration with business partners to understand project dependencies; disposition of individual business and technical requirements, and analysis of custom, standard and/or existing capacity needed to fulfill requirements. Additionally, once initial documentation, such as technical requirement documentation is validated and approved, the documents are base-lined and risks are identified and documented. Finally, resource availability is determined to perform the necessary design functions and tasks are consolidated when applicable.

In particular, in many projects, business and technical requirements are often defined manually and the associated risks and constraints are identified manually. Such a manual process allows for variances in the quality of the output and increases the design completion time. These variances in quality may be due to lack of technical resources, lack of access to existing documentation, lack of availability of third party/client resources, inexperience of design team associates and the like.

Additionally, in most project management systems, tracking of data is minimal or not performed at all. As such traceability, in terms of business requirements, technical requirements, technical constraints and the like, is lacking. In addition, in failing to track and/or store relevant data associated with a project, all downstream projects must be re-engineered and are incapable of leveraging off information learned from previous projects.

Therefore, a need exists to develop methods, systems, computer program products and the like which provide for a comprehensive project management system. A need exists to develop a system that adds project consistency to all phases of the project including, but not limited to, planning, technical requirements, project design, build and configuration. In addition, the desired project management system should consolidate, gather and store all planning, design and build inputs, such that, subsequent projects can leverage off information gathered and learned during previous projects. In particular, the desired system should allow for technical requirements to be identified based on previously completed technical requirements associated with the same business requirements seen in the current project. Additionally, the desired system should automate other aspects of the project, such as requisition decisioning and the like. The result of the desired system may include, but is not limited to, a reduction in design completion time, enterprise and global consistency of project output and the like.

### SUMMARY

The following presents a brief summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Methods, systems and computer program products are defined that provide for technical project management. Specifically, a consolidated end-to-end project delivery tool that serves to add efficiency and consistency to the planning, design and build processes of a technical project, such as an information technology project or the like. The system herein described reduces the complexity in the design and build processes, improves hand-off between the phases of the project. Additionally, through the re-use and reliance on existing designs, speed of design and quality of design is improved. Further embodiments of the invention, provide for measuring relevant metrics and identifying areas for process improvement.

A method for technical project management defines another embodiment of the invention. The method includes determining, at a computing device, one or more technical requirements for each of a plurality of identified business requirements of a technical project and determining, at a computing device, infrastructure design based on the technical requirements. The method further includes determining, at a computing device, build plans based on the infrastructure design and storing, at a centralized data store, a technical project record that includes the business requirements, the technical requirements, the infrastructure design, and the build plans.

In one specific embodiment the method includes identifying, at a computing device, approval contacts for various approval points in the technical project. In such embodiments the method may further include tracking approval by the identified approval contacts.

In another specific embodiment the method includes receiving, at a computing device, performance metrics associated with at least one of technical requirements, infrastructure design and build plans. In such embodiment the method may include generating, at a computing device, technical project reports based on the received performance metrics.

In yet another specific embodiment of the method, determining the one or more technical requirements further includes determining the one or more technical requirements for each of the plurality of identified business requirements based on historical technical project data stored in the centralized data store.

In another embodiment of the method, determining build plans based on the infrastructure design further includes identifying, at a computing device, one or more automated build processes based on the infrastructure design.

A system for technical project management provides for another embodiment of the invention. The system includes a technical requirement module stored in computer memory and configured to determine one or more technical requirements for each of a plurality of identified business requirements of a technical project. The system additionally includes an infrastructure design module stored in computer memory and configured to determine infrastructure design based on the technical requirements. Also, the system includes a build module stored in computer memory and configured to determine build plans based on the infrastructure design. Moreover, the system includes a data store configured to store a technical project record that includes the business requirements, the technical requirements, the infrastructure design, and the build plans.

In alternate embodiments the system includes an approval module stored in computer memory and configured to provide for identification of approval contacts for various approval points in the technical project. The approval may be further configured to track approval by the identified approval contacts.

Another alternate embodiment of the system includes a reporting module configured to receive performance metrics associated with at least one of technical requirements, infrastructure design and build plans. In such embodiments, the reporting module may be further configured to generate technical project reports based on the received performance metrics.

In specific embodiments of the system, the requirements module is further configured to determine the one or more technical requirements for each of the plurality of identified business requirements based on historical technical project data stored in the data store.

In other specific embodiments of the system, the build module is further configured to identify one or more automated build processes based on the infrastructure design.

Another embodiment of the invention is defined by a computer program product that includes a computer-readable medium. The medium includes a first set of codes for causing a computer to determine one or more technical requirements for each of a plurality of identified business requirements of a technical project. The medium additionally includes a second set of codes for causing a computer to determine infrastructure design based on the technical requirements and a third set of codes for causing a computer to determine build plans based on the infrastructure design. Additionally, the medium includes a fourth set of codes for causing a computer store a technical project record that includes the business requirements, the technical requirements, the infrastructure design, and the build plans.

Thus, as described in more detail below, systems, methods, computer programs and the like are defined that provide for managing a technical project. In particular, embodiments provide for an end-to-end project delivery tool that includes planning, defining the requirements, designing, building, approving and providing communication/reporting of the technical project. The technical project management delivery tool herein described automates the capture of data and other functionality, such as identification of technical requirements, design infrastructure, build workflows and the like, to add increased efficiency as it relates to the design and build phases of a technical project. Further, embodiments herein described consolidate all planning, design and build input into a central data store and automate the flow of this data throughout the planning, technical requirements, infrastructure design, build and configure phases.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of a system for technical project management, in accordance with an embodiment of the present invention;

FIG. 2 is a flow diagram of a method for technical project management, in accordance with embodiments of the present invention;

FIG. 3 is a block diagram of a requirements module within a technical project management system, in accordance with present embodiments;

FIG. 4 is a flow diagram of a method for determining technical requirements in a project management system, in accordance with present embodiments;

FIG. 5 is a flow diagram of an alternate method for determining technical requirements in a project management system, in accordance with present embodiments, in accordance with alternative embodiments of the invention; and

FIG. 6 is a detailed block diagram of a technical requirement module in a project management system, in accordance with present embodiments.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Present embodiments provide for systems, methods, computer program products and the like for managing a technical project. In particular, embodiments of the invention provide for an end-to-end project delivery tool that includes planning, defining the requirements, designing, building, approving and providing communication/reporting of the technical project. The technical project management delivery tool herein described automates the capture of data and other functionality, such as identification of technical requirements and the like, to add increased efficiency as it relates to the design and build phases of a technical project. In addition, the project management delivery tool herein described improves hand-offs and communication amongst disparate entities of a technical project.

In addition, by providing for the capture of data at all phases of the technical project, present embodiments of the invention, improve overall project delivery speed and quality through the re-use of data, such as the re-use of designs and the like. In this regard, the technical project management system herein described consolidates the planning, design and build inputs of a technical project into a central data store and automates the flow of such data throughout the planning, technical requirements, infrastructure design, build and/or configuration phases of the project. Such centralized data storing provides the ability to replicate previously completed technical requirements and infrastructure design; eliminating the need to recreate such data each time a similar project request is made.

Moreover, present embodiments provide for measurement of relevant metrics throughout the project delivery process and identification of areas requiring process improvement.

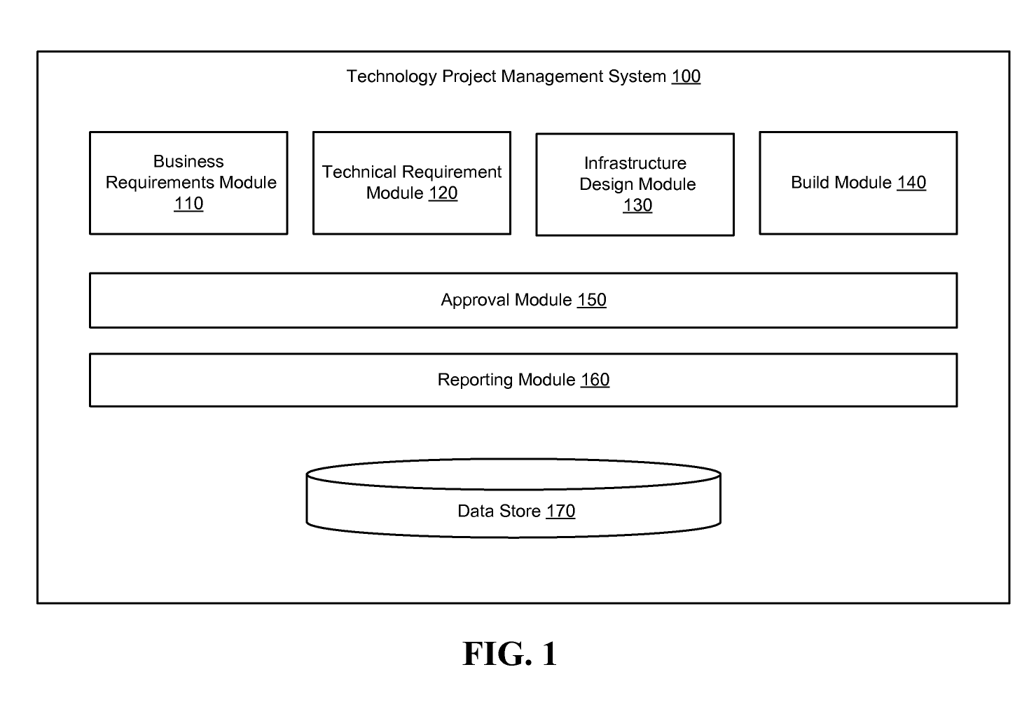

Referring to FIG. 1, a block diagram is depicted of a technology project management system 100. The technology project management system 100 includes a plurality of modules that serve to automate and streamline the overall technology project management process. It should be noted that the modules shown in FIG. 1 are by way of example only and, as such, embodiments of the present invention may include one or more or the modules shown and/or additional modules. As shown, the technology project management system 100 includes business requirements module 110, technical requirement module 120, infrastructure design module 130, build module 140, approval module 150, reporting module 160 and centralized data store 170.

Business requirements module 110 provides for identification and capture of business requirements. In addition, business requirements module 110 provides for initial planning of a technical project, such as identification and capture of the general information related to the technical project and/or identification and assessment of the technology impact of the project.

Technical requirement module 120 provides for identification and capture of technical requirements and, more specifically, the technical requirements that satisfy identified business requirements. In one embodiment of the invention, the technical requirements module 120 user defines and associates one or more technical requirements with a previously identified business requirement. In other embodiments of the invention, technical requirements are identified by mapping the identified technical project business requirements to one or more technical requirements and allowing for selection of the technical requirements based on the mapping and/or input of technical requirements not otherwise related to business requirements. In addition, the technical requirement module 120 provides for validating the technical requirements.

Additionally, the technical requirement module 120 provides for identification and capture of project administration data, such design elements, project contacts and sign-off and infrastructure dependencies; and technical project overview information, such as project assumptions, project risks and/or project constraints. Moreover, the technical requirement module provides for assessing and capturing application, hardware, storage, data retention, high-availability, security, encryption, authentication, operations, facilities, business volume, interface voice and throughput requirements and the like.

Infrastructure design module 130 provides for identifying the design objectives for the technical project and the high level and low level infrastructure/design requirements necessary to build or otherwise implement the technical project. The design requirements serve to identify the data elements, physical or otherwise, subsequently required by the build entity/team. In this regard, the infrastructure design module 130 receives the technical requirements outputted by the technology requirements module 120 and maps or otherwise identifies the design requirements based on the technical requirements. Further, the infrastructure design module 130 serves to validate technical project design solutions. In addition, the infrastructure design module 130 identifies individuals, teams/entities or the like involved in the build phase of the technical project, including third party entities, such as external vendors, suppliers or the like.

Build module 140 provides for automation of the build process by identifying the types of builds that can be automated and implementing automated builds based on the infrastructure/design requirements identified by infrastructure design module 130. In addition to creating and capturing an identified build process, the build module 140 tracks completion of the build by registering completion of build processes in the centralized data store 170. In addition, the tracking function of build module 140 insures or otherwise monitors scheduling requirements to insure that the technical project remains on schedule. Thus, proper automated alerts and/or automated notifications may be implemented to insure that build processes occur on schedule and the like. In this regard, the build module 140 may provide for monitoring and managing of external vendors and/or suppliers to insure that external procurements and/or services are delivered as scheduled and the like.

Approval module 150 provides for utilization of workflow capabilities to insure documentation is properly reviewed and approved by designated entities, processes are properly queued and the like. The documentation may include, but is not necessarily limited to, business requirement documentation, technical requirement documentation, design documentation, build documentation and the like. In this regard approval module 150 provides for approval of various steps, processes and the like associated with the business requirements module 110, the technical requirements module 120, the infrastructure design module 130 and/or the build module 140. The approval module streamlines the communication of documentation to the designated individuals and/or parties to further heighten efficiency in the overall technical project management scheme.

Reporting module 160 provides for automatically capturing predetermined technical project management metrics, such as on-time metrics, quality metrics and the like. In this regard reporting module 160 provides for capturing technical project management metrics from the business requirements module 110, the technical requirements module 120, the infrastructure design module 130 and/or the build module 140. In addition to capturing the metrics, reporting module 160 provides for automatically generating and communicating metrics related reports to designated individuals and/or parties/entities.

Centralized data store 170 provides for a project record database. Each technical project has an associated project record that includes all the information determined and collected at the various modules. In this regard, the project record may include, but is not limited to, business requirements, project risks, project assumptions, project constraints, technical requirements, project approval designations, infrastructure design, build/workflow plans, project performance metrics, project performance reports, and the like. The historical aspect of the project records allows for subsequent technical projects to leverage off of previous project records as a basis for determining courses of action. As such, technical requirements, infrastructure design, build plans, and the like can be determined for a present technical project based on previously learned experiences of a previous project.

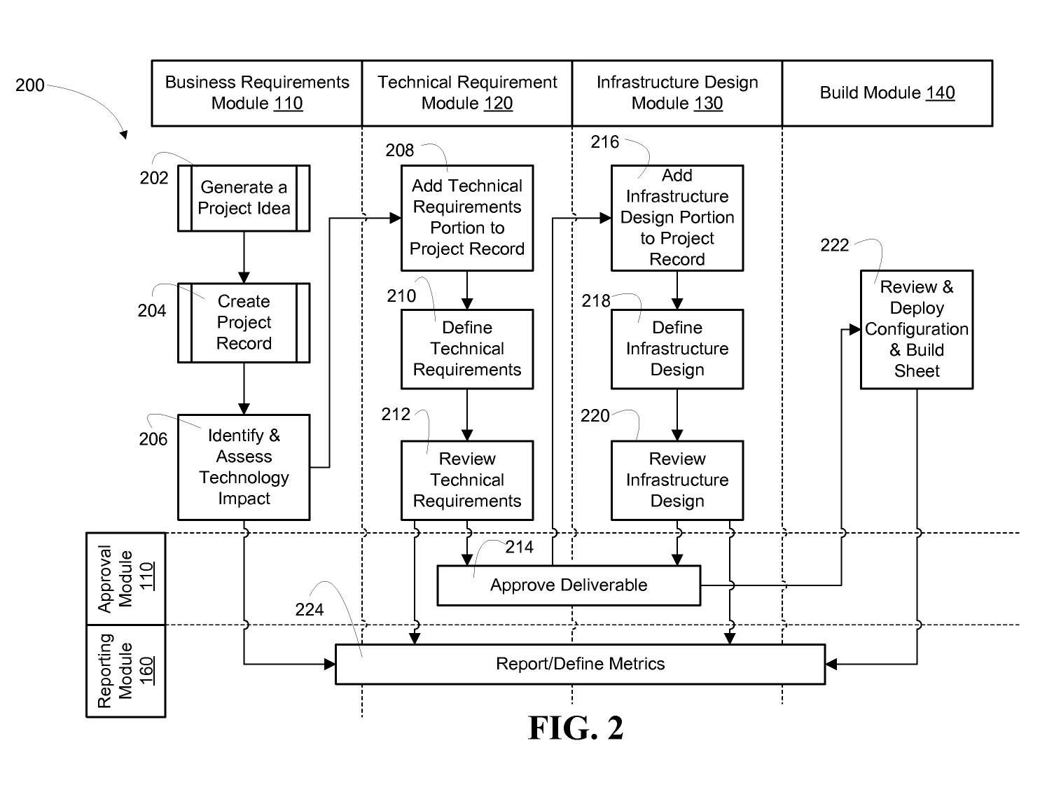

Referring to FIG. 2, a flow diagram is presented of a method 200 for technical project management implementing the modules shown in FIG. 1, in accordance with an embodiment of the invention. At Event 202, a technical project idea is generated by an appropriate project stakeholder. The technical project is defined by requiring the implementation of technical resources, such as new infrastructure, modifications to existing infrastructure, computer network and the like. In one embodiment of the method, the project idea may be captured by the business requirements module 110 of technical project management system 100. At Event 204, the project is originated by creation of a project record within the business requirements module 110. The record is subsequently stored in the central data store and used in various different phases/modules of the technical project management process. The project record defines project information, such as project name, requester/stakeholder name, project sponsor, sponsor hierarchy, project priority, and the like. At Event 206, the technology impact of the project is identified and assessed. The technology impact aids in identifying the business requirements and/or technology requirements associated with the technical project.

At Event 208, a technical requirements portion is added to the project record within the technical requirement module 120. In one embodiment of the invention, the requirement requirements are captured by an information-gathering application configured to create and deploy electronic form solutions to gather information off-line, efficiently and reliably. In other embodiments of the invention, the technical requirements may be captured by a Graphical User Interface (GUI) application configured to provide online or network access to the technical requirement portion of the project record.

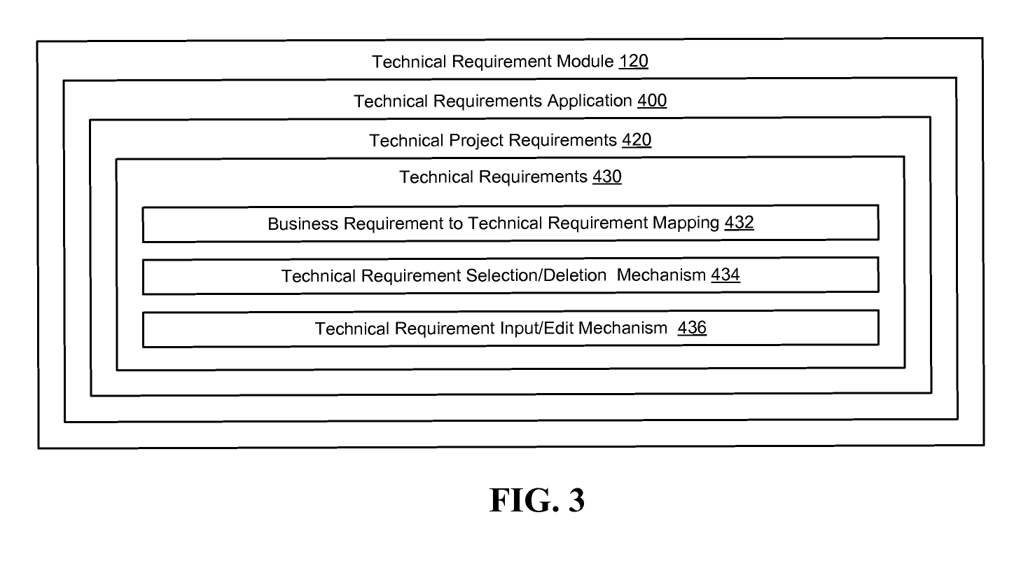

As such, at Event 210, technical requirements are defined and captured within the requirement requirements portion of the project record. As described in relation to FIG. 3 and in accordance with specific embodiments, the technical requirement module 120 may be configured to provide a mapping of identified business requirements to one or more technical requirements. In those embodiments in which the mapping provides for mapping a business requirement to a plurality of technical requirements, a user, such as a design team administrator or the like, may select which of the mapped technical requirements are applicable to the present technical project. Additionally, in other specific embodiments, technical requirements may be inputted by the user, such as, for example, in the event that the technical requirement module 120 provides for a user to define the technical requirement(s) based on the predefined business requirement or the technical requirement is not currently mapped to a business requirement.

In addition to identifying and capturing technical requirements, the technical requirement portion of the project record provides for identifying and capturing application, hardware, storage, data retention, high-availability, security, encryption, authentication, operations, facilities, business volume, interface voice and throughput requirements and the like.

At Event 212, a requirements review is conducted by a designated party/entity, such as an infrastructure/build team or the like, to ensure the accuracy and completeness of the technical requirement portion of the project record.

At Event 214, the technical requirements are approved by designated individuals and/or entities. In addition, any other deliverables identified at the technical requirement module that require approval, are approved at this stage. In specific embodiments of the invention, approval of a deliverable is a pre-requisite of initiating a further deliverable. For example, the technical requirements may require approval prior to initiating design requirement identification and the like. In addition, an approval may be required within the technical requirements module prior to initiating another deliverable within the technical requirements module.

At Event 216, the infrastructure design requirements portion is added to the project record within the infrastructure design module 130. In one embodiment of the invention, the infrastructure design requirements are captured by an information-gathering application configured to create and deploy electronic form solutions to gather information off-line, efficiently and reliably. In other embodiments of the invention, the infrastructure design requirements may be captured by a Graphical User Interface (GUI) application configured to provide online or network access to the infrastructure design requirement portion of the project record.

At Event 218, infrastructure design is defined and captured within the infrastructure design portion of the project record. As previously discussed, according to specific embodiments, the technical project system provides for mapping the technical requirements to one or more deign requirements. The design requirements identify the requirements to build the technical project, including the data elements required by the build team. In addition to identifying design requirements, costs and funding associated with the design requirements may be defined and/or identified. In addition to defining infrastructure design, at this stage of the process, data elements may be procured, both internally and externally from vendors/suppliers. The data elements may include physical elements, such as hardware or the like, intellectual elements, such as software or the like and/or services.

At Event 220, an infrastructure design review is conducted by a designated party/entity, such as an infrastructure/build team or the like, to ensure the accuracy and completeness of the infrastructure design portion of the project record.

At Event 214, the infrastructure design is approved by designated individuals and/or entities. In addition, any other deliverables identified at the infrastructure design module that require approval, are approved at this stage. In specific embodiments of the invention, approval of a deliverable is a pre-requisite of initiating a further deliverable. For example, the infrastructure design may require approval prior to initiating review and deployment of the build and the like. In addition, an approval may be required within the infrastructure design module prior to initiating another deliverable within the infrastructure design module.

At Event 222, a configuration and build sheet is reviewed and deployed that defines the build requirements for the technical project. As previously discussed, the build module 140 may define build requirements/build sheets based on the design requirements and the like. Deployment of the build sheet provides for initiation, implementation and completion of the technical project.

At Event 224, technical project management metrics are determined and/or collected from the various modules that include reporting metrics or information related to reporting metrics. In one specific embodiment, the technical project management metrics are collected from the technical requirement 110 and infrastructure design 120 modules. However, in other embodiments technical project management metrics may be collected from the business requirement module 100 and/or the build module 140, as well. In addition, as previously noted the reporting module 160 is configured to generate reports based on the reporting metrics and communicate the reports to predetermined entities, such as management teams or the like.

Turning the reader's attention to FIG. 3 a block diagram is presented of the technical requirement module 120 within a technical project management system, in accordance with embodiments of the present invention. The technical requirement module 120 includes a technical requirements application 400. As previously noted, the technical requirements application 400 may take the form of an information-gathering application, such as InfoPath®, available from Microsoft Corporation of Redmond, Wash. In such an application, the user is able to download or otherwise obtain the necessary technical requirement documentation, provide inputs to the document and upload the document to the central data store. In this regard, the information-gathering application provides for off-line utilization. Additionally, the technical requirements application 400 may take the form of a network-accessible Graphical User Interface (GUI) application that may be accessed either internally via an intranet or externally via the Internet or the like.

The technical requirements application 400 includes a technical project requirements section 420 that includes a technical requirement sub-section 430 that includes a business requirement-to-technical requirement traceability matrix 432. In one embodiment of the invention, traceability matrix is configured to map/link a previously identified business requirement to one or more technical requirements. In one such embodiment, a user may identify one or more technical requirements associated with a business requirements. In another embodiment, each previously identified business requirement is mapped/linked to one specific technical requirement. In other embodiments, each previously identified business requirement is mapped/linked to one or more technical requirements. In those embodiments in which each business requirement is mapped/linked to one or more technical requirements, the technical requirements 430 section may include technical requirements selector 434 that is configured to provide for user selection of one or more than one of the mapped technical requirements. It should also be noted that while the business requirements may be mapped to one specific technical requirement or one or more technical requirements, more than one technical requirement may be mapped/linked to the same specific business requirement. Stated from a different perspective, numerous business requirements may be mapped/linked to the same technical requirements.

In addition, the technical requirement 430 section may include a technical requirement input/edit mechanism 436 configured to receive user inputs that define a technical requirement or edit a technical requirement. Input of a technical requirement may be necessary if the technical requirements is not mapped to a business requirement and/or does not require mapping/linking to a business requirement. Editing of a technical requirement if the mapped technical requirements provides for an inadequate definition of the requirement in light of the technical project and/or the business requirement.

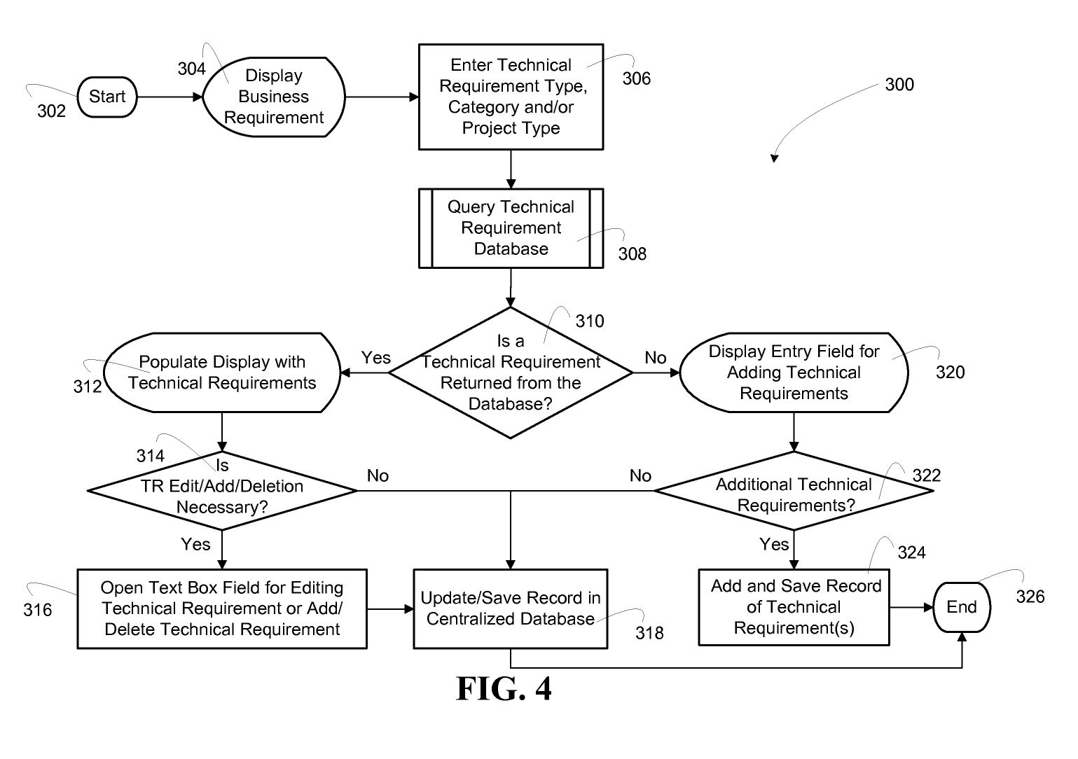

FIG. 4 is a flow diagram of a method 300 for determining technical requirements within technical project management system, in accordance with one embodiment of the present invention. The method 300 is typically associated with a technical requirement GUI application. At Event 302, the method is initiated. It should be noted that prior to the method, business requirements may be defined and/or mapped/linked to one or more technical requirements. The mapping/linking of business requirements to technical requirements may be based on previous technical projects and, in some embodiments, a business requirement may be automatically mapped to a technical requirement if a previous technical project associated the technical requirements with the business requirement.

At Event 304, a business requirement is displayed that is associated with the technical project. The business requirement may have been previously defined, such as during a business requirements module stage, or the business requirement may have been previously defined during the technical requirement module stage. At Event 306, a user enters or otherwise selects technical requirement criteria, such as a technical requirement type, a technical requirement category and/or a project type (i.e., new or existing technical project). At Event 308, based on the displayed business requirement and the inputted technical requirement criteria, the technical requirement database is queried to determine which technical requirements are mapped/linked to the business requirement and meet the inputted technical requirement criteria.

At Decision 310, a determination is made as to whether the query returns at least one technical requirement from the database. If the query does return at least one technical requirement then, at Event 312, the display is populated with one or more technical requirements, such as via a pull-down menu or the like. At Decision 314, a determination is made as to whether an edit, addition or deletion to the one or more technical requirements is necessary. If an edit is necessary, at Event 316, a text box field is opened to provide for editing the text of a selected technical requirement or adding a technical requirement and/or one or more displayed technical requirements are selected for deletion. After edit/addition/deletion of technical requirements or if, at Decision 314, it is determined that no edits/deletions are necessary, at Event 318, the record of technical requirements is updated/saved in the centralized data store.

If, at Decision 310, no technical requirements are returned from the business requirement-to technical requirement mapping/linking database or if the application is configured such that a user defines the technical requirement associated with a business requirement then, at Event 320, an entry field is displayed for adding one or more technical requirements. At Decision 322, a determination is made as to whether one or more technical requirements are necessary based on the displayed business requirement. In some instances, a business requirement may not warrant technical requirements. If technical requirements are determined to be necessary then, at Event 322, one or more technical requirements are added and saved to the record of technical requirements in the centralized data store. If technical requirements are determined to not be necessary then, at Event 324, the record of technical requirements is updated/saved to reflect no technical requirements associated with the business requirements. Once the technical requirement record has been updated/saved, at Event 326, the method is completed.

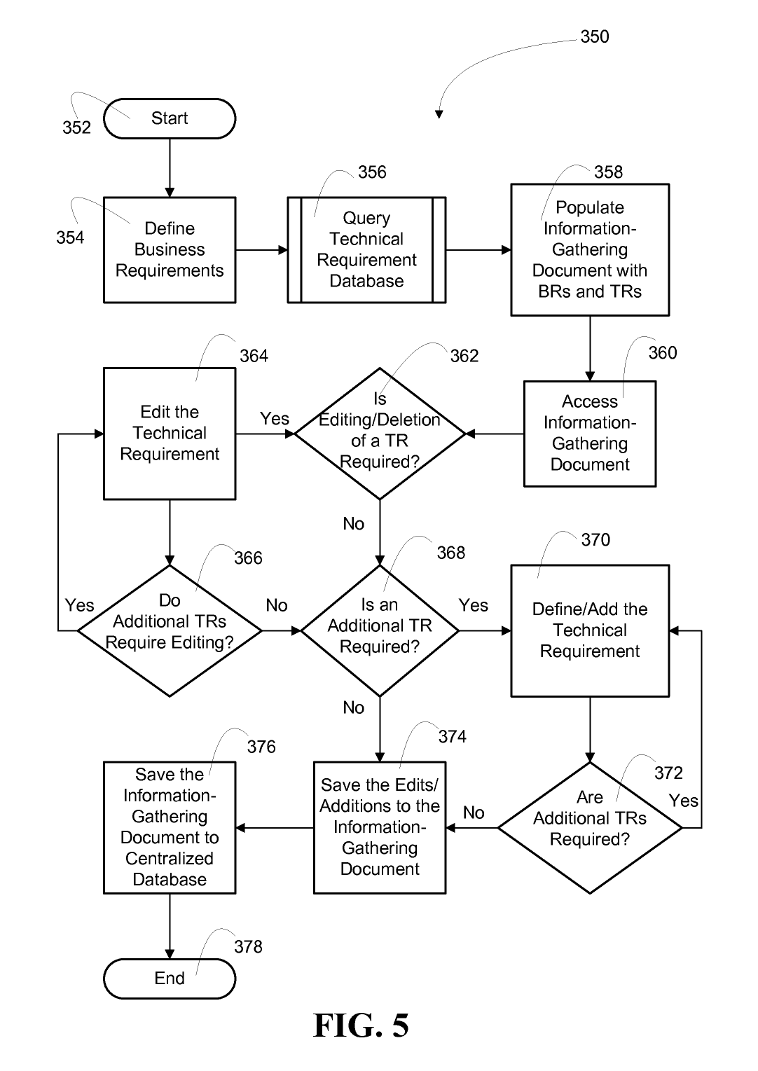

FIG. 5 is a flow diagram of a method 350 for determining technical requirements within technical project management system, in accordance with one embodiment of the present invention. The method 350 is typically associated with a technical requirement information gathering application. At Event 352, the method is initiated. The mapping/linking of business requirements to technical requirements may based on previous technical projects and, in some embodiments, a business requirement may be automatically mapped to a technical requirement if a previous technical project associated the technical requirements with the business requirement.

At Event 354, business requirements are defined for a specific project. As previously noted, the business requirements may be defined during a business requirements module stage.

At optional Event 356, the technical requirement database is queried to determine which technical requirements are mapped to each of the business requirements. The technical requirements may be mapped to the business requirements based on previous technical project business requirement-to-technical requirement associations. In other embodiments, the information gathering application is configured to provide for a user to define technical requirements associated with a predefined business requirement. In such embodiments, querying the database to determine which requirements are mapped to the business requirements is not necessary. At Event 358, the information-gathering document is populated with business requirements and, optionally, one or more technical requirements. The document may be populated with the business the requirements and optional technical requirements, prior to user access of the document or in conjunction with a user accessing the document. As previous noted, a business requirement may be associated with one specific technical requirement, a business requirement may be associated with one or more technical requirements, or a user may be required to define the technical requirement(s) for the associated business requirement.

At Event 360, a user accesses an information gathering document associated with the specific project. As previously noted, a user may download the information gathering document or otherwise be provided with network access to the information gathering document.

At optional Decision 362, in those embodiments, in which the business requirements are mapped to a technical requirement(s), a determination is made as to whether one of the technical requirements requires editing or deletion. If one of the technical requirements requires editing or deletion then, at Event 364, the technical requirement is edited or deleted accordingly. Editing or deletion of a technical requirement may be needed based on the specific needs of the technical project and/or to better align with the business requirement in light of the technical project. At Decision 366, a determination is made as to whether additional technical requirements require editing or deletion. If additional technical requirements require editing or deletion, the process iteratively returns to Event 364 and the user provides the necessary edits and/or deletes technical requirements requiring such.

If no further technical requirements require editing or deletion or if no editing or deleting of technical requirements was required, at Decision 368, a determination is made, in certain embodiments, as to whether the application is configured such that technical requirements are required to be defined for an associated business requirement or, in other embodiments, as to whether additional technical requirements, beyond those mapped to a business requirement, are required. If a technical requirement is required to be defined/added, at Event 370, the additional technical requirement is defined/added. The additional technical requirement may be associated with a business requirement or the additional technical requirement may be a stand-alone technical requirement requiring no association with a business requirement. In certain instances, a technical project may necessitate technical requirements absent an associated business requirement. At Decision 372, a determination is made as to whether additional technical requirements are required to be added or defined. If additional technical requirements are required, the process iteratively returns to Event 370 and the user provides the necessary information needed to add a technical requirement.

If no additional technical requirements need to be added of if no technical requirements were added, at Event 374, the edits/deletions and/or additions to the technical requirements are saved to the information-gathering document. At Event 376, upon subsequent completion of other information-gathering document sections, the information-gathering document is saved to a centralized data store for subsequent reliance for defining design requirements and the like. At Event 378, the process is completed.

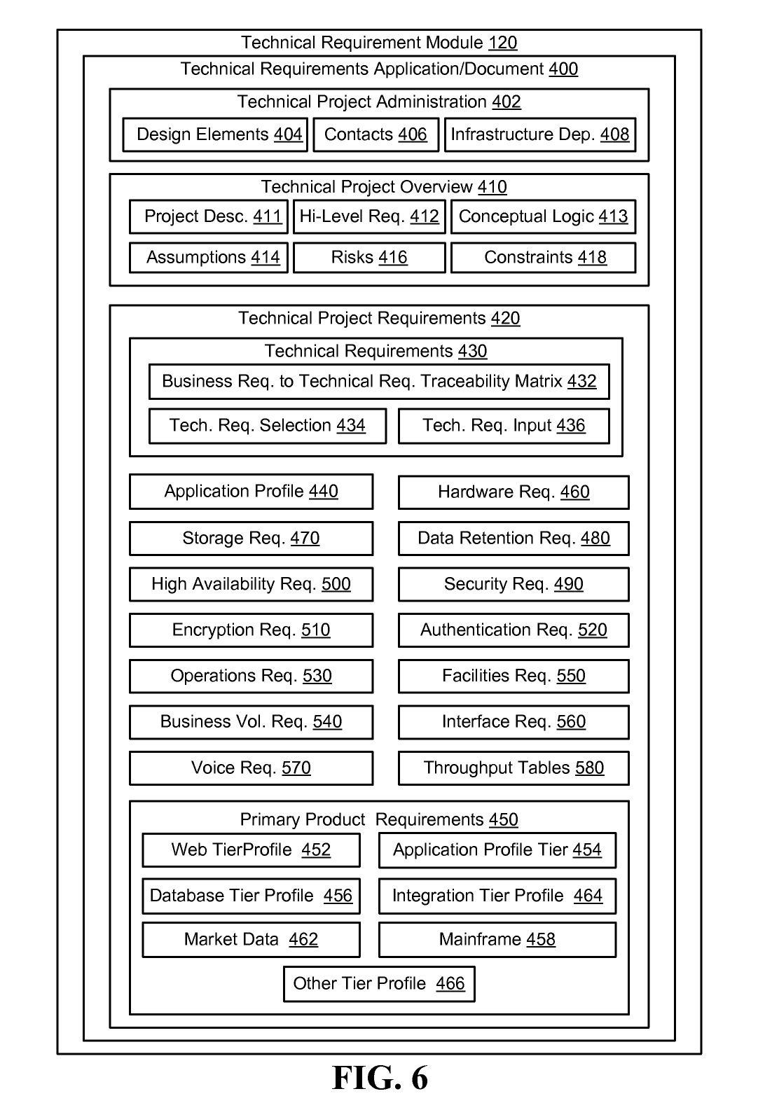

Referring to FIG. 6 a block diagram is depicted of a technical requirement module 120 of a technical project management system and, more specifically, a technical requirements application 400 implemented in conjunction with a technical requirements module, in accordance with embodiments of the present invention. As depicted and described, the technical requirements application may be an information-gathering application or the like, which takes the form of an information-gathering document, such as technical requirements document or the like.

The technical requirements application 400 serves to automate specific actions and tasks associated with gathering technical requirements and identifying risks, assumptions and constraints. The automation provides integration of pertinent administrative information, business requirements, reference architectures and the like, from systems of record. In this regard, automation pertains to business requirement collection, technical requirement traceability and constraint identification.

The technical requirements application/documentation 400 includes a project information section, a revision history section, a change control history section and a project administration section. All of which are not depicted in FIG. 6 for the sake of clarity. The project information section includes information that may be auto-populated from a project planning record stored in the centralized data store or the information may be input or edited by the user of the technical requirements document 400. The project information section includes, but is not limited to, project name, project number, project organization, project priority and the like. The revision history section catalogs, summarizes and timestamps changes to the technical requirements document and the revision history section catalogs, summarizes and timestamps edits to the specific technical requirement document.

As an introductory portion, the technical requirements document 400 a technical project administrative section 402 and a technical project overview section 410. The project administration section 402 includes a design element sub-section 404 that is configured to provide for user input of infrastructure design elements, is infrastructure design is required. If infrastructure design is not required, the design element sub-section 404 may be configured to provide for justification.

The project administration section 402 may additionally include contact and signoff matrix sub-section 406 that is configured to provide for a user to input the names of individuals or entities required to approve various stages of the technical project and provides for sign-off/approval status, sign-off/approval date and related comments, such as conditions or the like. The contact and signoff matrix subsection may link to a corporate directory and or management hierarchy listing for the purpose of identifying the requisite individual or entity responsible for approving a process or stage on the project management scheme. Additionally, project personnel may be pulled from the centralized data store, such as the business requirements module or the like, and auto-populated within the contact and sign-off matrix subsection.

Once the individuals or entities are listed in the contact and sign-off matrix sub-section, the system may be configured to communicate automated electronic communication, such as e-mails, text messages or the like, to the designated contacts or signoff entities to approve a related step in the technical project management system. Additionally, the approval module 150 (shown in FIG. 1) may be configured to allow for a sign-off party to approve, approve with conditions or disapprove via response to the electronic communication. In addition, the approval module (150) may be configured to track the response time for approvals and provide for automated electronic communication reminders in the event approval is for received within a designated predetermined time period.

In addition to contacts and signoffs, sub-section 406 may include identification of vendors/external sources, including vendor contact, vendor email, vendor telephone numbers and the like. The vendor information may be pulled from a vendor database and auto-populated within the vendor portion of the contact and sign-off matrix subsection or the vendor information may be manually inputted by a user. The vendor information provided in the vendor contact sub-section may subsequently be automatically imported to an infrastructure design document included in the infrastructure design module 130 (shown in FIG. 1).

Additionally, the contacts and signoffs sub-section 406 may include high level milestones that provide for automated or manual input of current expectations regarding the timing (e.g., estimated start date and estimated finish date) of the project to allow for early evaluation of the feasibility of these time expectations. The high-level milestones may subsequently be automatically imported to an infrastructure design document included in the infrastructure design module 130 (shown in FIG. 1).

The project administration section 402 may additionally include contact and infrastructure dependency/related initiatives sub-section 408 that provides for manual or automated entry of the project dependencies and/or related initiatives that may be impacted by the technical project, such as impacted by a time delay in the project or the like. A project dependency may be another technical project or any other initiative associated with the business entity. The project dependency/related initiative sub-section 408 may provide for input of the dependency, the production timeline of the dependency the data the dependency is added and the like.

The technical project overview section 410 may include a project description sub-section 411 that provides for manual or automated (e.g., pre-populated) entry of project description information. The project description information may include, but is not limited to, overall objectives of the project, definition of terms/acronyms specific to the project, background of the project, if the project is part of a multi-phase effort, the ultimate goal of the multi-phase effort and the like. The pre-populated information may be subjected to editing at the discretion of the user based on project needs.

Additionally, technical project overview section 410 may include high level requirements section 412 that provides for manual entry of a summary of the technical requirements, risks, assumptions and the like presented in greater detail in forthcoming sections of the technical requirements application/document 400.

In addition, technical project overview section 410 may include conceptual logical configuration diagram sub-section 413 that provides for manual or automated linking to conceptual logical configuration diagrams or the like. As such, conceptual logical configuration diagram sub-section 413 may provide for a network-accessible link, such as a hyper-link or the like, to diagrams, flow charts, figures or the like.

The technical project overview section 410 includes project assumptions sub-section 414, project risks sub-section 416 and design issues/project constraint sub-section 418. Project assumptions sub-section 414 provides for a listing of one or more project design assumptions. Standard design assumptions may be provided in the listing by default and other design assumptions may be automatically or manually added to the listing. In addition to the assumptions, sub-section 412 provides for an associated sign-off approval entity/role and sign-off approval name for the assumption. The sign-off approval entity/role and/or sign-off approval name for an assumption may be auto-populated from the contact and sign-off matrix of the project administration section, discussed previously. Additionally, the project assumption sub-section may include an input for a confirming party/individual and a confirmation date. The confirming party input entry may provide a link to a corporate directory or the like and the confirmation date entry field may provide for auto-population of the current date and access to a viewable calendar.

Project risk sub-section 416 provides for a listing of one or more project design risks. Design risks may be automatically or manually added to the listing. In addition to the risks, sub-section 416 provides for an associated risk presenter name and entity/role input field and an open date entry field. The open date entry field may provide for auto-population of the current date and access to a viewable calendar. The project risk sub-section 414 additionally may provide for a risk mitigation plan entry field and a resolution date entry field. The risk mitigation entry field provides for manual input of the planned course(s) of action to mitigate or otherwise lessen the risk. The resolution date field provides for manual input of the date on which the risk was resolved, if applicable.

Design issue/project constraints sub-section 418 provides for a listing of one or more project design issues and/or technology constraints associated with the project. The information provided for in the project constraint sub-section 418 may subsequently be automatically imported to an infrastructure design document included in the infrastructure design module 130 (shown in FIG. 1). In addition to the constraints, sub-section 418 provides for an associated constraint presenter name/role input field, a constraint assignment name/role entry field and an open date entry field. The open date entry field may provide for auto-population of the current date and access to a viewable calendar. The project constraint sub-section 418 additionally may provide for resolution approach entry field and a target resolution date entry field. The risk mitigation entry field provides for manual input of the planned course(s) of action to resolve the issue/constraint. The target resolution date field provides for manual input of a target date for resolving the constraint/issue. The project constraint sub-section may also provide for a status entry field to indicate if the constraint/issue is currently open, closed or otherwise and a priority entry field to indicate if the constraint/issue is, for example, a low, medium or high priority constraint/issue.

The technical requirements application 400 additionally includes technical project requirements section 420. The technical requirements section 420 may include one or more of technical requirements sub-section 430, application profile sub-section 440, primary product requirement sub-section 450, hardware requirement sub-section 460, storage requirement sub-section 470, data retention requirement sub-section 480, security requirement sub-section 490, high availability requirement sub-section 500, encryption requirement sub-section 510, authentication requirement sub-section 520, operations and monitoring requirement sub-section 530, business volume requirement sub-section 540, facilities requirement sub-section 550, interface requirement sub-section 560, voice requirement sub-section 570 and the like. Each of the subsections may be configured to be collapsible within the application, if the user designates a sub-section as not being applicable to the specified technical project.

Technical requirement sub-section 420 which was previously discussed in relation to FIG. 3 includes business requirement to technical requirement mapping/traceability matrix 432, a technical requirement selection/deletion mechanism 434 and a technical requirement input/edit mechanism 436. The business requirement to technical requirement mapping/traceability matrix 432 provides for a business requirement to mapped/linked to, or defined/identified for, one or more technical requirements. In certain embodiments of the invention, the technical project requirements application/document 400 may be configured to provide for a used to identify and manually enter a technical requirement(s) associated with a predefined business requirement. In such embodiments of the invention, the business requirements are automatically populated from a business requirement document or the like stored in a centralized data store.

In other embodiments of the invention, the technical project requirements application/document 400 may be configured to automatically map a predefined business requirement to one or more technical requirements. The technical requirements associated with the business requirement may be determined based on historical technical project information (i.e., previous mappings/links between business requirements and technical requirements). Thus, the technical requirements may be automatically populated based on the outcome of the determination. In one embodiment of the invention, each business requirement is mapped to one technical requirement. In such embodiments, the same technical requirement may be mapped to more than one business requirement. In another embodiment of the invention, each business requirement is mapped/linked to one or more technical requirement. In such embodiments, the technical requirement selection/deletion mechanism 434 may be implemented to select or otherwise delete one or more of the mapped technical requirements for the specific project.

Technical requirement input/edit mechanism 436 provides for defining or adding a technical requirement or editing a pre-existing technical requirement based on project needs. As previously noted, defining/adding a technical requirement may be required if the technical project requirement subsection 430 is configured such that a predefined business requirement requires a user to manual define and enter one or more technical requirements. Thus, a defined/added technical requirement may be mapped/linked to a business requirement or the added technical requirement may be a stand-alone technical requirement that does not require association with a business requirement.

The application profile sub-section 440 includes a listing of queries related to the technical project application/software. The application profile sub-section 440 provides for each application/software associated with the project to be listed, either manually or automatically. Manual listing provides for the user to input identifying criteria, such as application number or the like and automated listing provides for pre-population of the list based on the business requirements and or previous projects. Each of the listed applications has a set of queries and each query provides for a related response entry field. The response entry field may be auto-populated from information provided in the business requirements module, the central data store or the like or a user may manually enter responses. In instances in which responses to the queries are auto-populated, the application profile section provides for editing the responses, as applicable. In addition, information/responses provided to the application profile sub-section 440 may subsequently be automatically imported to an infrastructure design document included in the infrastructure design module 130 (shown in FIG. 1). The queries included in the application profile sub-section 440 may include, but are not limited to, business units affected by the application, description of the overall application architecture, application users, upstream/downstream components/applications affected, criticality of the application, hours of operation, application significance ranking and the like.

The primary product requirements sub-section 450 provides for various requirements associated with the primary product related to the technical project. The primary product requirement sub-section 450 may include one or more of web tier profile 452, application tier profile 454, database tier profile 456, mainframe tier profile 458, market data 462, integration tier profile 464 and any other tier profile 466. Each of the profiles 450-466 provide for a listing of related queries and a response entry field for responding to the queries. If the any of profiles are deemed by the user to be not applicable, the profile may be collapsed and a text box provided to input a reason for non-applicability. In addition, each of the tier profiles provide for queries to be application specific, based on the applications listed/identified in the application profile sub-section 440. For example, if five applications are listed in the application profile sub-section 440, each of the tier profiles 452-462 may include up to five different sets of queries, wherein each set of queries applies to an application/software.

Each of the queries in the tier profiles provide for a related response entry field. The response entry field, provides for a user to manually enter responses or for the response to automatically pre-populated based on data in the business requirements module or the centralized data store. In instances, in which the responses are pre-populated, the responses may be edited by the user, as need be. In addition, the response field may be limited to yes/no replies or a text entry field. Additionally, a yes response entry field, or in some instances a no response entry field may provide for a text box entry field for the purpose of further elaboration. In addition, information/responses provided to the primary product requirements sub-section 450 may subsequently be automatically imported to an infrastructure design document included in the infrastructure design module 130 (shown in FIG. 1). Additionally, profiles 450-466 provide for adding additional queries or comments related to the specific sub-section.

The web/presentation tier profile 452 includes a listing of queries related to web/presentations needed for the technical project. The application tier profile 454 includes a listing of queries related to application/software needed for the technical project. The web/presentation and the application/software queries may include, but are not limited to, pre-existing applications, hardware/server requirements, operating system requirements, security requirements and the like.

The database tier profile 456 includes a listing of queries related to database(s) needed for the technical project. Database queries may include, but are not limited to, pre-existing databases, hardware/server requirements, operating system requirements, hosting requirements, data replication requirements, database availability requirements, database transaction profile, third party application hosting requirements and the like. The mainframe tier profile 458 includes a listing of queries related to mainframe needs for the technical project. Mainframe queries may include, but are not limited to, mainframe components, impacted entities, volume changes, batch volume run plans, time sensitive batch cycles involved monitoring requirements, and the like.

The market data 462 includes a listing of queries related to the market for the primary product affected by the technical project. The market queries may include, but are not limited to, market data feed needs, pre-existing market data feeds, specific market data application requirements and the like. The integration tier profile 464 includes a listing of queries related to the integration of the technical project with other systems, such as messaging services/systems, business-to-business systems, and the like. The interface queries may include, but are not limited to, application requirements related to the integrated system, security requirements, high availability requirements, monitoring requirements, synchronization concerns, messaging-specific queries and the like.

The other tier profile 466 includes a listing of queries related to any other facet of the primary product, such as reporting, document management and the like. The other queries may include, but are not limited to, existing applications, hardware requirements, operating system/software requirements, security requirements, reporting requirements and the like.

Technical project requirements section 420 include hardware requirements sub-section 460 that includes a listing of queries related to project hardware requirements and an associated response entry field. The response entry field may be a yes/no selection, a check box or a text entry field. The hardware queries may include, but are not limited to, pre-existing hardware, hardware environment requirements, contingency hardware requirements, application fallover plans, service levels required, available surplus hardware and the like.

Storage requirements sub-section 470 includes a listing of queries related to project storage requirements and an associated response entry field. The response entry field may be a yes/no selection, a check box or a text entry field. The hardware queries may include, but are not limited to, type of storage requirements, sixe of existing storage, growth rate of existing storage and the like. Data retention requirements sub-section 480 includes a listing of queries related to project storage requirements and an associated response entry field. The response entry field may be a yes/no selection, a text entry field or the like. The data retention queries may include, but are not limited to, date retention requirements, data retention policies and the like.

Security requirements sub-section 490 includes a listing of queries related to security requirements and an associated response entry field. The response entry field may be a yes/no selection, a text entry field or the like. The data retention queries may include, but are not limited to, classification of application data, classification of transmitted data, data encryption requirements, external network communication requirements, firewall requirements and the like. High availability requirements sub-section 500 includes a listing of queries related to the need employ high availability hardware in the technical project and an associated response entry field. The high availability queries may include, but are not limited to, high availability server use, server load balancing requirements and the like. Encryption requirements sub-section 510 includes a listing of queries related to encryption requirements for the project. The encryption queries. The data retention queries may include, but are not limited to, encryption application tiers, Secure Socket Layer (SSL) requirements and tiers to which it applies, database encryption requirements and the like.

Authentication requirements sub-section 520 includes a listing of queries related to authentication requirements and an associated response entry field. The response entry field may be a yes/no selection, a text entry field or the like. The authentication queries may include, but are not limited to, authentication and authorization requirements, role based security requirements, unique authentication requirements, service identification requirements, digital certificate requirements and the like. Operations and monitoring requirements sub-section 530 includes a listing of queries related to operations and monitoring requirements of the technical project. The response entry field may be a yes/no selection, a text entry field or the like. The operations and monitoring queries may include, but are not limited to, production run hours, component monitoring requirements, external monitoring requirements, customer use monitoring/survey requirements, fallover, resiliency and/or reconnect logic use and testing and the like.

Business volume requirements sub-section 540 includes a listing of queries related to business volume associated with the technical project. The response entry field may be a yes/no selection, a text entry field or the like. The business volume queries may include, but are not limited to, capacity planning requirements, relative annual growth attributed to project, total number of transactions per time period, season peak information, similar workloads in other projects, is a capacity increase request required, expected number of users, peak transaction rate and the like. Facilities requirements sub-section 550 includes a listing of queries related to facilities affected by the technical project. The facilities queries may include, but are not limited to, data center location requirements, potential data centers in containment, and the like.

Interfaces requirements sub-section 560 includes a listing of queries related to interface requirements for the project. The interface queries may include, but are not limited to, type of interface, input/output to project, internal/external interface, interface description, frequency of use, supported protocol, average and peak transaction volume interface format, and the like. Voice requirements sub-section 570 includes a listing of queries related to voice/telephony requirements for the technical project. The voice queries may include, but are not limited to, voice requirements, call center requirements, call volumes, data retention period, call statistics requirements, telephony requirements, and the like. Throughput tables 580 include a listing of queries related to throughput tables for the technical project.

Thus, as described herein, present embodiments provide for methods, systems, and computer program products that provide for managing a technical project. In particular, embodiments of the invention provide for an end-to-end project delivery tool that includes planning, defining the requirements, designing, building, approving and providing communication/reporting of the technical project. The technical project management delivery tool herein described automates the capture of data and other functionality, such as identification of technical requirements and the like, to add increased efficiency as it relates to the design and build phases of a technical project. In addition, the project management delivery tool herein described improves hand-offs and communication amongst different disparate entities of a technical project.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for technical project management, the method comprising:
identifying, at a computing device, one or more technical requirements for each of a plurality of identified business requirements of a technical project;
determining, at a computing device, infrastructure design based on the technical requirements;
determining, at a computing device, build plans based on the infrastructure design; and
storing, at a centralized data store, a technical project record that includes the business requirements, the technical requirements, the infrastructure design, and the build plans.

2. The method of claim 1, further comprising identifying, at a computing device, approval contacts for various approval points in the technical project.

3. The method of claim 1, further comprising tracking approval by the identified approval contacts.

4. The method of claim 1, further comprising receiving, at a computing device, performance metrics associated with at least one of technical requirements, infrastructure design and build plans.

5. The method of claim 4, further comprising generating, at a computing device, technical project reports based on the received performance metrics.

6. The method of claim 1, wherein identifying the one or more technical requirements further comprises determining the one or more technical requirements for each of the plurality of identified business requirements based on historical technical project data stored in the centralized data store.

7. The method of claim 1, wherein determining build plans based on the infrastructure design further comprises identifying, at a computing device, one or more automated build processes based on the infrastructure design.

8. The method of claim 1, wherein storing further comprises storing the technical project record in a technical project database.

9. The method of claim 8, further comprising accessing the technical project database to determine the one or more technical requirements for each of the plurality of identified business requirements based on previous associations between business requirements and technical requirements.

10. A system for technical project management, the system comprising:
a technical requirement module stored in computer memory and configured to determine one or more technical requirements for each of a plurality of identified business requirements of a technical project;
an infrastructure design module stored in computer memory and configured to determine infrastructure design based on the technical requirements;
a build module stored in computer memory and configured to determine build plans based on the infrastructure design; and
a data store configured to store a technical project record that includes the business requirements, the technical requirements, the infrastructure design, and the build plans.

11. The system of claim 10, further comprising an approval module stored in computer memory and configured to provide for identification of approval contacts for various approval points in the technical project.

12. The system of claim 11, wherein the approval module is further configured to track approval by the identified approval contacts.

13. The system of claim 10, further comprising a reporting module configured to receive performance metrics associated with at least one of technical requirements, infrastructure design and build plans.

14. The system of claim 13, wherein the reporting module is further configured to generate technical project reports based on the received performance metrics.

15. The system of claim 10, wherein the requirements module is further configured to determine the one or more technical requirements for each of the plurality of identified business requirements based on historical technical project data stored in the data store.

16. The system of claim 10, wherein the build module is further configured to identify one or more automated build processes based on the infrastructure design.

17. The system of claim 10, wherein the data store is further configured to store the technical project record in a technical project database.

18. The system of claim 17, wherein the requirements module is further configured to access the technical project database to determine the one or more technical requirements for each of the plurality of identified business requirements based on previous associations between business requirements and technical requirements.

19. A computer program product comprising:
a computer-readable medium comprising:
a first set of codes for causing a computer to determine one or more technical requirements for each of a plurality of identified business requirements of a technical project;
a second set of codes for causing a computer to determine infrastructure design based on the technical requirements;
a third set of codes for causing a computer to determine build plans based on the infrastructure design; and
a fourth set of codes for causing a computer store a technical project record that includes the business requirements, the technical requirements, the infrastructure design, and the build plans.

20. The computer program product of claim 19, further comprising a fifth set of codes for causing a computer to identify approval contacts for various approval points in the technical project.

21. The computer program product of claim 20, wherein the fifth set of codes are further configured to cause the computer to track approval by the identified approval contacts.

22. The computer program product of claim 19, further comprising a fifth set of codes for causing a computer to receive performance metrics associated with at least one of technical requirements, infrastructure design and build plans.

23. The computer program product of claim 22, wherein the fifth set of codes is further configured to cause the computer to generate technical project reports based on the received performance metrics.

24. The computer program product of claim 19, wherein the first set of codes is further configured to cause the computer determine the one or more technical requirements for each of the plurality of identified business requirements based on historical technical project data stored in the centralized data store.

25. The computer program product of claim 19, wherein the third set of codes is further configured to cause the computer to identify one or more automated build processes based on the infrastructure design.

26. The computer program product of claim 19, wherein the fourth set of codes is further configured to cause the computer to store the technical project record in a technical project database.

27. The computer program product of claim 26, wherein the first set of codes is further configured to cause the computer to access the technical project database to determine the one or more technical requirements for each of the plurality of identified business requirements based on previous associations between business requirements and technical requirements.
